(19) United States
(12) Patent Application Publication
(10) Pub. No.: US 2007/0177400 A1
(43) Pub. Date: Aug. 2, 2007

(54) Vehicle lighting device

(75) Inventor: Masashi Tatsukawa, Shizuoka (JP)

Correspondence Address: OSHA LIANG L.L.P., 1221 MCKINNEY STREET, SUITE 2800, HOUSTON, TX, 77010, US

(73) Assignee: KOITO MANUFACTURING CO., LTD., Tokyo (JP)

(21) Appl. No.: 11/657,976

(22) Filed: Jan. 25, 2007

(30) Foreign Application Priority Data
Jan. 31, 2006 (JP) 2006-023697

(51) Int. Cl. F21V 7/00

(52) U.S. Cl. 362/514

(57) ABSTRACT

A vehicle lighting device includes a reflection type lamp unit including a first LED that emits light downward; and a reflective face that reflects part of the light emitted by the first LED outward to the front of the vehicle lighting device. Part of the light emitted by the first LED is output, as directly emitted light, directly to the front of the vehicle lighting device. The reflective face includes a first reflective portion that reflects light as vertically almost parallel light and as horizontally diffused light, and a second reflective portion that reflects light below the light reflected by the first reflective portion and above the directly emitted light.

### BACKGROUND OF INVENTION

1. Field of the Invention

The present invention relates to a vehicle lighting device that includes a lamp unit for which a semiconductor light emitting device is employed as a light source.

2. Background Art

Recently, a light emitting diode (LED) lamp was developed. The LED lamp is characterized in that it provides increased luminance, for which only a small consumption of power is required, and is regarded as a next-generation vehicle light source. As shown in FIG. 13, for example, a headlamp for a vehicle disclosed in patent document 1 has a reflection type lamp unit 1 that includes: a semiconductor light emitting device (LED) 3, which constitutes a light source; and a reflector 5, which is disposed forward below the LED 3.

According to patent document 1, the reflector 5 has a reflective face 5a, having the shape of a parabolic cylinder, from which astigmatic foci FL are horizontally extended. At the two sides of the reflective face 5a, side walls (not shown) are formed.

The astigmatic foci FL are so aligned that they extend forward perpendicular to a unit central axis Ax. The LED 3 is a white light emitting diode wherein an emission chip 3a, about 0.3 to 1 mm square, is arranged so as to be directed down, vertically, along the astigmatic foci FL.

In the lamp unit 1, the light reflected by the reflector 5 becomes, in the vertical direction, parallel light rays that are directed slightly downward, and becomes, in the horizontal direction, light that is widely scattered, from side to side, at the unit central axis Ax. Furthermore, some types of these vehicle headlamps are so designed that not only the reflection type lamp unit 1, but also, a PES lamp unit is included in a lamp body. According to this integrated type vehicle lighting device, the reflection type lamp unit and the PES lamp unit are separately arranged within the same lamp body. It should be noted that a reflection type lamp unit may be formed using a reflective face that employs a paraboloid of revolution as a reference.

[Patent Document 1] JP-A-2005-141919

In this reflection type lamp unit, the arrangement is such that the LED 3 is directly visible from the front, and the light reflected by the reflector 5, as is apparent in FIG. 14, forms a light distribution pattern PL 1, while light directly emitted by the LED 3 forms a light distribution pattern PL 2 in front of the light distribution pattern PL 1. Therefore, interposed between the reflected LED light, propagated by the reflector 5, and the directly emitted LED light (emitted to the front and downward) is a darker portion PLb. In this case, the quantity of the light component emitted directly to the front and downward by the LED 3 is not large; however, since the light distribution pattern PL 2 is directly to the front, nearer to a driver, the impression gained by the driver is that the area included within the light distribution pattern PL 2 is relatively more brightly lit than is the darker portion PLb. Furthermore, according to the integrated type vehicle lighting device, wherein the conventional reflection type lamp unit and the PES lamp unit are included within the same lamp body, the reflection type lamp unit and the PES lamp unit are separately arranged. Thus, the spatial usage efficiency is low, and the size of such a lighting device is increased.

### SUMMARY OF INVENTION

One or more embodiments of the present invention provide a vehicle lighting device for which, without increasing the device size, the interposition of a darker portion between reflected light and light directly emitted by an LED, to the front and downward, is prevented, and the view to the front is improved.

Embodiments of the present invention include at least the following configurations.

(1) A vehicle lighting device comprising:

a reflection type lamp unit comprising a first LED that emits light downward; and a reflective face that reflects light emitted by the first LED outward to the front of the vehicle lighting device, wherein part of the light emitted by the first LED is output, as directly emitted light, directly to the front of the vehicle lighting device, and

wherein the reflective face comprises:

a first reflective portion that reflects light emitted vertically as almost parallel light and as horizontally diffused light, and

a second reflective portion that reflects light below the light reflected by the first reflective portion and above the directly emitted light.

(2) The vehicle lighting device according to (1), wherein the first reflective portion and the second reflective portion are integrally formed, and wherein the second reflective portion is located near an upper end of the first reflective face.

(3) The vehicle lighting device according to (1) or (2), wherein the first reflective portion is formed of a plurality of reflective segmentssuch that adjacent segments are contiguously formed and extended substantially vertically; wherein the plurality of reflective segments comprise a central reflective segment located below the first LED; and wherein the second reflective portion is formed and connected to the central reflective segment.

(4) The vehicle lighting device according to one of (1) to (3), further comprising:

a PES lamp unit, which forms a cut line pattern, comprising:

a second LED that emits light upward;

a third reflective portion that reflects light emitted by the second LED;

a linear light blocking portion that reflects part of the light reflected by the third reflective portion; and

a projection lens,

wherein the first LED and the second LED are arranged on an upper face and a lower face of a horizontally arranged light source holder, and

wherein the first LED is located to the rear of the projection lens.

(5) A vehicle lighting device according to (4), wherein the first reflective portion, the second reflective portion, and the third reflective portion are integrally formed.

According to one or more embodiments of the invention, the vehicle lighting device includes the second reflective portion, which reflects light at a lower level than light is reflected by the first reflective portion. Thus, light reflected by the second reflective portion can be directed toward the dark portion that is interposed between the light reflected by the first reflective portion and the light component that is directly emitted to the front and downward by the LED, so that throughout the irradiation range the light appears to be contiguous, and the view to the front is improved. Especially for the headlamps and auxiliary headlamps of a two-wheeled vehicle, since near a driver, at the front of the irradiation range, the visible area provided for the driver is large, a contiguous irradiation range can effectively improve the view to the front.

Furthermore, according to one or more embodiments of the invention, the first reflective portion and the second reflective portion are integrally formed, and the second reflective portion is formed near the upper end of the reflective face. Therefore, when the second reflective portion that transmits reflected light downward is formed on the reflective face, only a small segment of a light component is blocked by parts (e.g., the extension component) positioned in front of the reflective portion, and lighting is efficiently performed. Further, when the reflective portions are integrally formed, a gap (light leakage) does not occur, and the lighting efficiency is increased.

According to one or more embodiments of the invention, the first reflective portion is formed of a plurality of reflective segments. Of these reflective segments, connection reflective segments are prepared contiguously to either side of the central reflective segment located below the LED so that at least one reflective segment is connected to one of sides of the central reflective segment, and the second reflective portion is contiguously formed with the central reflective segment. Therefore, the second reflective portion is located near the upper end of the central reflective segment, which is nearest the LED and from which diffused light emission is enabled bilaterally and symmetrically. As a result, reflected light can be accurately emitted within a desired irradiation range.

Furthermore, according to one or more embodiments of the invention, the vehicle lighting device further comprises: the PES lamp unit, which includes the second LED that emits light upward, the third reflective portion, the linear light blocking portion and the projection lens, and the first LED and the second LED that are located on the upper face and the lower face of the horizontally arranged light source holder. Thus, a light distribution pattern having an accurate cut line can be formed. Further, since the two LEDs are fixed to one light source holder, and the first LED is located at the rear of the projection lens, the individual optical components can be compactly assembled, and a reduction if the size of the lighting device is possible. In addition, since the first LED can be hidden by the projection lens, almost no internal portion is visible directly from the front, and an improved design can be provided.

Moreover, according to one or more embodiments of the invention, since the first, the second, and the third reflective portions are integrally formed, the number of components and the manufacturing costs can be reduced, and further downsizing can be obtained.

Other aspects and advantages of the invention will be apparent from the following description and the appended claims.

### BRIEF DESCRIPTION OF DRAWINGS

FIG. 1 is a vertical cross-sectional view of a vehicle lighting device according to an embodiment of the present invention.

FIG. 2 is a transverse cross-sectional view of the vehicle lighting device shown in FIG. 1.

FIG. 3 is an exploded perspective view of the vehicle lighting device shown in FIG. 1.

FIG. 4 is an exploded perspective view of a light source holder.

FIG. 5 is a side view of a first reflective portion.

FIG. 6 is a front view of the first reflective portion.

FIG. 7 is an operation explanatory diagram showing the light distribution state of the vehicle lighting device shown in FIG. 1.

FIG. 8 is a diagram showing an iso-illuminance curve for a PES lamp unit.

FIG. 9 is a diagram showing an iso-illuminance curve for a reflection type lamp unit.

FIG. 10 is a diagram showing an iso-illuminance curve, for the vehicle lighting device, obtained by synthesizing the iso-illuminance curves for the PES lamp unit and the reflection type lamp unit.

FIG. 11 is a perspective diagram showing a light distribution pattern for a low beam that is formed on a virtual vertical screen, at a distance 25 m ahead of the vehicle lighting device shown in FIG. 1, by light emitted to the front by the vehicle lighting device.

FIG. 12 is a horizontal cross-sectional view of a first reflective portion formed according to one embodiment of the invention.

FIG. 13 is an cross-sectional view of the essential portion of a conventional reflection type lamp unit.

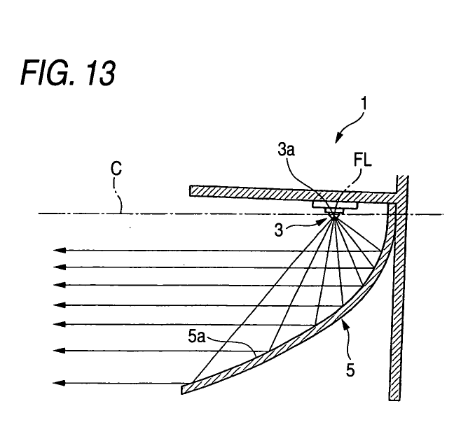

FIG. 14 is a perspective view of a light distribution pattern for a low beam that is formed on a virtual vertical screen, at a distance 25 m ahead of a conventional vehicle lighting device, by light emitted to the front by the vehicle lighting device.

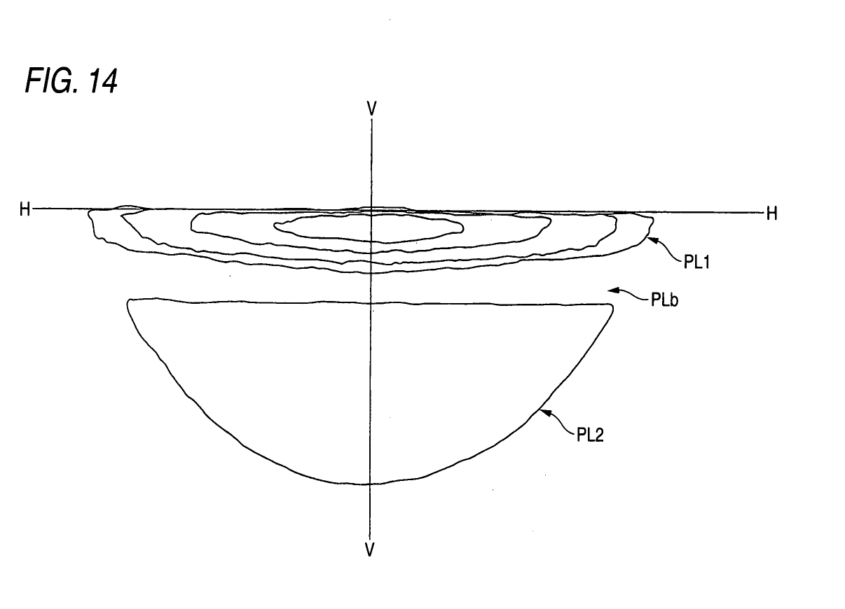

### DETAILED DESCRIPTION

A vehicle lighting device according to the one or more embodiments of the present invention will now be described with reference to the drawings.

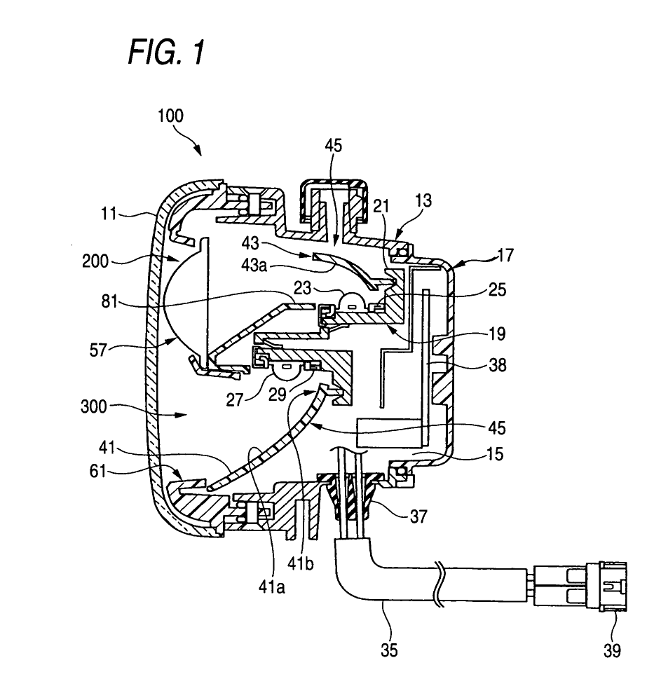

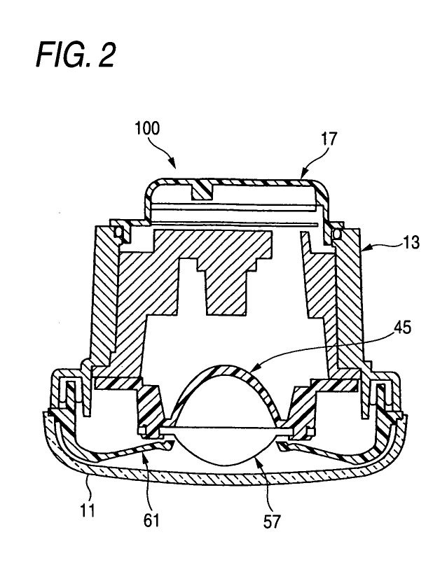

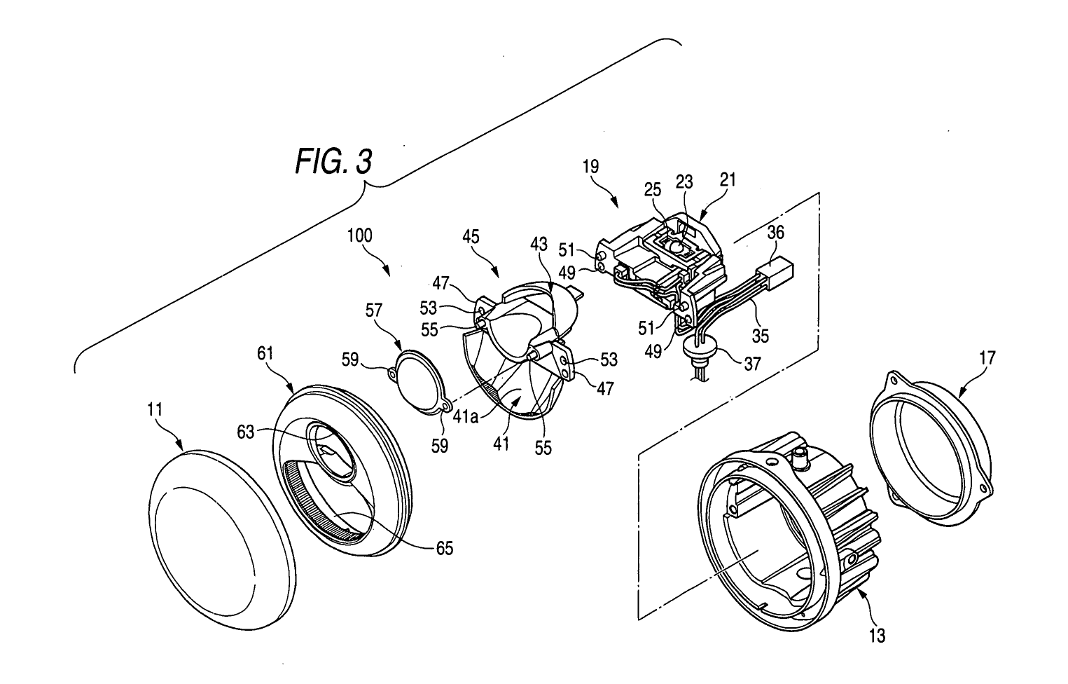

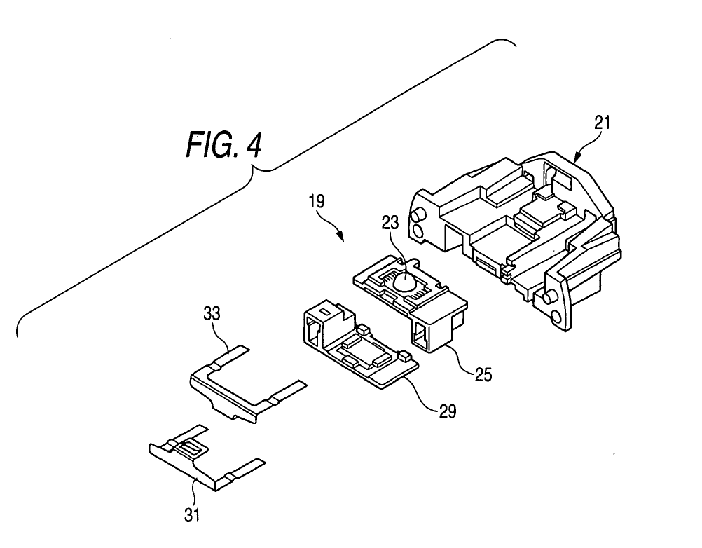

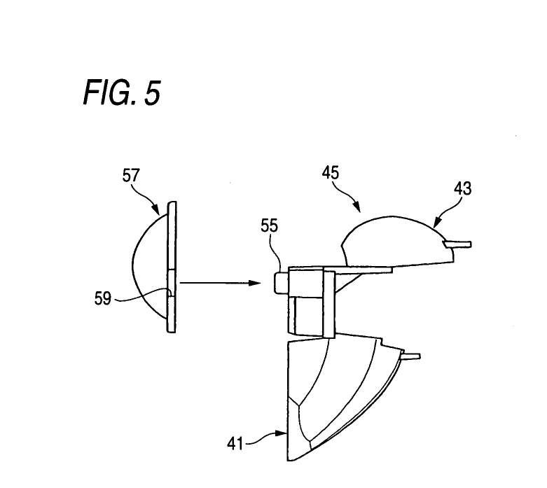

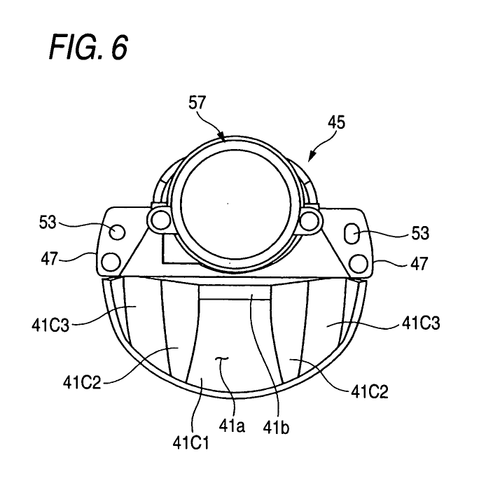

FIG. 1 is a vertical cross-sectional view of a vehicle lighting device according to one embodiment. FIG. 2 is a transverse cross-sectional view of the vehicle lighting device in FIG. 1. FIG. 3 is an exploded perspective view of the vehicle lighting device in FIG. 1. FIG. 4 is an exploded perspective view of a light source holder. FIG. 5 is a side view of a first reflective portion. FIG. 6 is a front view of the first reflective portion.

As shown in FIGS. 1 and 3, for a vehicle lighting device 100, a lamp unit 200, which is a PES lamp unit, and a lamp unit 300, which is a reflection type lamp unit, are respectively arranged at the top and bottom of a lamp chamber that is formed of a transparent, light transmitting cover 11, and a lamp body 13.

An opening 15 is formed in the rear end of the lamp body 13, and a watertight cap 17 that can be opened to expose the lamp chamber is detachably attached to the opening 15 using screws, for example. A light source holder 19 is located between the watertight cap 17 and the light transmitting cover 11. As shown in FIG. 4, for the light source holder 19, a second substrate 25, on which a second LED 23 is mounted that serves as the light source of the lamp unit 200, is attached to the upper face of a base 21, while a first substrate 29, on which a first LED 27 is mounted that serves as the light source of the lamp unit 300, is attached to the lower face of the base 21.

After the first substrate 29 and the second substrate 25 are attached to the base 21, stopper plates 31 and 33 are employed to prevent these substrates 29 and 25 from falling off. A bus bar (not shown), which contacts a power supply circuit for the first substrate 29 and the second substrate 25, is laid in the base 21, and the end of the bus bar is connected to a power cable 35. A connector 36, used to facilitate a connection, is coupled with the terminal end of the power cable 35. The connector 36 is attached to a connector (not shown) that is mounted on a control circuit board 38 stored in the watertight cap 17, and power is supplied by the control circuit board 38, via the connector 36 and the power cable 35, to the first LED 27 and the second LED 23.

As shown in FIG. 3, a reflector 45 is arranged between the light source holder 19 and the light transmitting cover 11. This reflector 45 is provided by integrally forming a reflective face 41, which includes a first reflective portion 41a and a second reflective portion 41b used for the first LED 27 that will be described in detail later, and a second reflective face (a third reflective portion 43) used for the second LED 23. To mount the reflector 45, right and left fitting pieces 47 are aligned with right and left holes 49 of the light source holder 19 and fastened using screws (not shown). It should be noted that in FIG. 3, reference numeral 51 denotes a positioning pin and reference numeral 53 denotes a positioning hole.

Lens positioning protrusions 55 are formed on both sides of the third reflective portion 43 of the reflector 45, and are inserted into holes 59 for fixing a projection lens 57, which will be described later. Between the reflector 45 and the light transmitting cover 11, a circular extension 61 is arranged so that it is fitted around the front opening edge of the lamp body 13. A projection lens opening hole 63, where the projection lens 57 is to be exposed, and a nearly fan-shaped hole 65, through which light is emitted by the lamp unit 300, are respectively formed at an upper position and a lower position of the extension 61.

The arrangements of the lamp units 300 and 200 will now be specifically explained.

The lamp unit 300 includes: the first LED 27, which serves as a light source; and

the reflective face 41, which is part of the reflector 45 for reflecting light emitted by the first LED 27. The first LED 27 is located vertically downward, and is fixed to the base 21 through the first substrate 29.

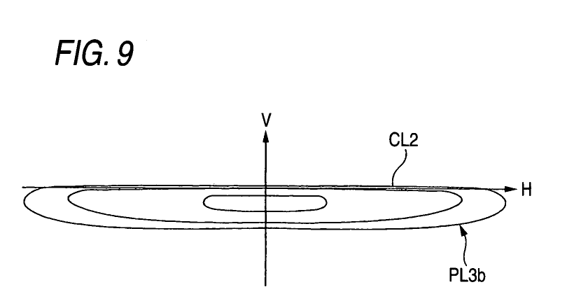

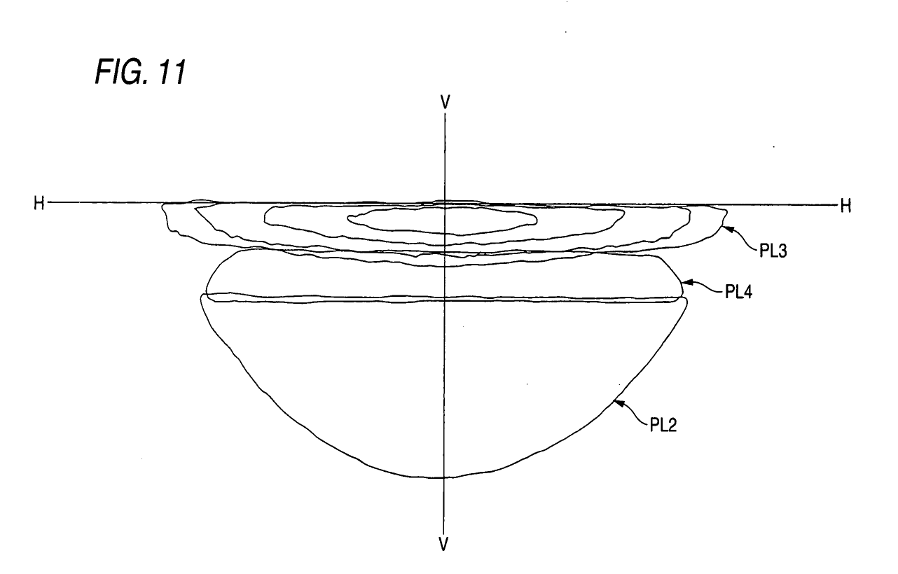

Two reflective portions that have different functions are provided for the reflective face 41 of the reflector 45, i.e., the first reflective portion 41a, which reflects light emitted by the first LED 27 and forms a light distribution pattern PL 3b (see FIG. 9) to the front, and the second reflective portion 41b, which reflects, at a level below the light reflected by the first reflective portion 41a, light emitted by the first LED 27 and forms a light distribution pattern PL 4 (see FIG. 11) to the front.

Specifically, the first reflective portion 41a is located beneath the first LED 27, and is a reflective face formed by employing nearly a paraboloid of revolution as a reference. The first reflective portion 41a is so designed that light emitted by the first LED 27 is reflected, as nearly parallel light, vertically, and is reflected, as diffused light, horizontally. In this case, the second reflective portion 41b is provided near the upper end of the reflective face that serves as the first reflective portion 41a.

The second reflective portion 41b is a reflective face by which light emitted by the first LED 27 is to be reflected to a level lower than the light reflected by the first reflective portion 41a. The second reflective portion 41b is contiguous with the first reflective portion 41a, so that it is located near the upper end of the reflective face 41.

In one or more embodiments, the first reflective portion 41a and the second reflective portion 41b are integrally formed, and the second reflective portion 41b is located near the upper end of the reflective face 41. Therefore, when the second reflective portion 41b that reflects the reflected light downward is formed on the upper portion of the reflective face 41, only a small quantity of a light component is blocked by a component (e.g., the extension 61) located in front of the reflective face 41, and lighting is efficiently performed. Further, when the reflective portions are integrally formed, a gap (light leakage) does not occur, and the lighting efficiency can be increased.

Furthermore, the first reflective portion 41a is formed of a plurality of reflective segments, so that segments adjacent to each other are contiguously formed and are extended substantially vertically. Preferably, the reflective segments include: a central reflective segment 41C1, which includes the XZ plane (a plane parallel to the plane of paper in FIG. 1) that passes through the first LED 27, i.e., which is located below the first LED 27; a connection reflective segment 41C2, to which at least one reflective segment 41C3 is connected, and which is contiguously prepared to either side of the central reflective segment 41C1. In this case, the second reflective portion 41b is contiguously formed near the upper end of the central reflective segment 41C1.

As described above, in one or more embodiments, the first reflective portion 41a includes the reflective segments 41C1, 41C2 and 41C3, and the connection reflective segments 41C2, to which at least one reflective segment 41C3 is connected, are contiguously formed on either side of the central reflective segment 41C1. Further, the second reflective portion 41b is contiguously formed near the upper end of the central reflective segment 41C1. Therefore, the second reflective portion 41b is arranged near the upper end of the central reflective segment 41C1, which is nearest to the first LED 27 and for which diffusion emission is enabled bilaterally and symmetrically. As a result, reflected light can be accurately emitted within a desired irradiation range.

Furthermore, in the lamp unit 300, light emitted by the first LED 27 is reflected forward at the first reflective portion 41a and the second reflective portion 41b as slightly downward directed, horizontal diffused light. This light is output to the front of the lamp through the light transmitting cover 11.

The arrangement of the projector lamp unit 200 will now be explained.

The lamp unit 200 includes: the second LED 23, which serves as a light source, the third reflective portion 43, and a linear light blocking unit (a light control member) 81. The second LED 23 is a white light emitting diode that includes a single light emitting chip about 1 mm square, and is supported by the vertically upward second substrate 25.

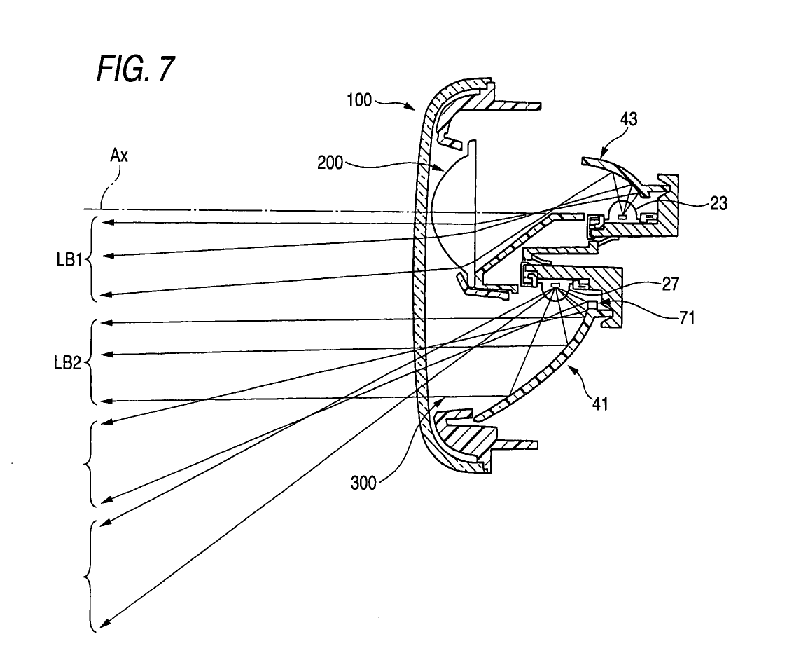

The third reflective portion 43 is a substantially dome shape member located above the second LED 23, that has a reflective face 43a for condensing light emitted by the second LED 23 and for reflecting it forward near a light axis Ax (see FIG. 7). This reflective face 43a is so formed that the vertical distance from the second LED 23 to the reflective face 43a is about 10 mm.

The reflective face 43a is formed by using, as a reference, an almost paraboloid of revolution that employs the light axis Ax as its center. Specifically, the cross section of the reflective face 43a that includes the light axis Ax is set so it is almost elliptical, and the eccentricity thereof is gradually increased from the vertical cross section to the transverse cross section. It should be noted that the rear vertex of the elliptic that forms each cross section is set in the same position. The second LED 23 is located at the first focal point of the elliptic that forms the vertical cross section of the reflective face 43a, and thus, on the reflective face 43a, light emitted by the second LED 23 is condensed and is reflected forward near the light axis Ax. In the vertical cross section that includes the light axis Ax, the light is converged substantially at the second focal point of the elliptic.

The projection lens 57 of the lamp unit 200 is a flat convex lens, for which the surface to the front is convex and the surface to the rear is flat, and both the upper and lower sides are chamfered. The projection lens 57 is located along the light axis Ax, so that the rear focal point is positioned slightly to the rear relative to the second focal point of the reflective face 43a of the third reflective portion 43. Therefore, an image on the focal face, including the rear focal point, is projected as an inverted image to the front.

The light control member 81 is a plate member provided for the third reflective portion 43, and is shaped like a crest, when viewed from the front of the lamp, and the upper face of the light control member 81 serves as a light control face, for which the reflective face process has been performed. Because a part of the light reflected by the reflective face 43a is reflected upward onto the light control face, the light control member 81 changes light that is to be output upward, through the projection lens 57, into light that is to be output downward, through the projection lens 57. Through this process, the luminance flux utilization rate for light emitted by the second LED 23 is increased.

Specifically, the light control face is a horizontal cutoff formation face that is extended horizontally, to the right and left, along the light axis Ax. Also, the front edge, e.g., the ridge line between the light control face and the front end face of the light control member 81, is so set that it passes through a rear focal point F of the projection lens 57. After light emitted by the second LED 23 is reflected by the reflective face 43a of the third reflective portion 43, part of this reflected light enters the light control face of the light control member 81 while the remainder enters the projection lens 57. At this time, light entering the light control face is reflected upward, onto the light control face, is transmitted to the projection lens 57, and is output, through the projection lens 57, as downward light. As described above, by employing the second LED 23, the third reflective portion 43, and the projection lens 57, the lamp unit 200 can serve as a PES lamp unit that forms a cut line pattern.

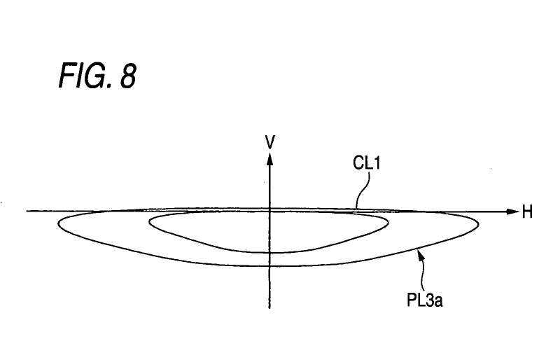

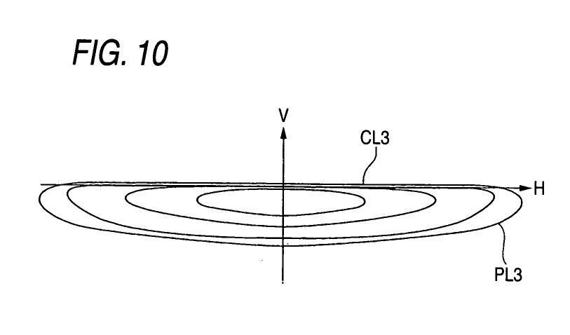

FIG. 7 is an explanatory diagram of operation showing the light distribution state of the vehicle lighting device shown in FIG. 1. FIG. 8 is a diagram showing an iso-illuminance curve for the PES lamp unit. FIG. 9 is a diagram showing an iso-illuminance curve for the reflection type lamp unit. FIG. 10 is a diagram showing an iso-illuminance curve, for the vehicle lighting device, obtained by synthesizing the iso-illuminance curves for the PES lamp unit and the reflection type lamp unit. FIG. 11 is a perspective diagram showing a light distribution pattern for a low beam that is formed on a virtual vertical screen, arranged at a 25 mm distance ahead of the vehicle lighting device in FIG. 1, by light emitted to the front by the vehicle lighting device.

As shown in FIG. 8, a light beam LB1 emitted by the lamp unit 200 in FIG. 7 is formed so that it spreads vertically under a horizontal cut line CL1. As a result, the light distribution pattern PL 3a is provided, according to which the road surface in front of a vehicle is lighted within a broad range to the front.

On the other hand, as shown in FIG. 9, a light beam LB2 emitted by the lamp unit 300 is so formed that it is spread widely to the right and to the left relative to a line V-V under a horizontal cut line CL2. As a result, the light distribution pattern PL 3b is provided, according to which the road surface to the front of a vehicle is lighted across a wide range. Because different values are designated for the right and left diffuse reflective angles of the individual diffuse reflective segments that constitute the first reflective portion 41a, a diff-used area formation pattern is a light distribution pattern wherein the luminous intensity is gradually reduced toward the circumferential edge.

When the two light distribution patterns PL 3a and PL 3b are superimposed, a light distribution pattern PL3, shown in FIG. 10, is obtained that spreads out vertically under a horizontal cutoff line CL3, so that the road surface to the front of a vehicle is lighted within a wide range, and that also spreads widely to the right and left relative to a line V-V, so that the road surface in front of a vehicle is lighted across a wide range.

For the vehicle lighting device 100, not only does the light reflected by the lamp units 200 and 300 form the light distribution pattern PL3 in FIGS. 10 and 11, but also, direct light emitted by the first LED 27 of the lamp unit 300 forms a light distribution pattern PL2 in front of the light distribution pattern PL3. Further, at a darker portion interposed between the light distribution patterns PL3 and PL2, a light distribution pattern PL4 is formed by light reflected by the second reflective portion 41b of the lamp unit 300. As a result, the light distribution patterns PL3 and PL2, which are conventionally separated due to the occurrence of a darker portion, are contiguous with the light distribution pattern PL4. Therefore, the view can be improved.

In the vehicle lighting device 100, as described above, the first LED 27 and the second LED 23 are respectively located on the upper face and the lower face of the horizontally arranged light source holder 19. With this arrangement, a light distribution pattern having an accurate cut line can be formed. Furthermore, because the two LEDs are fixed to one light source holder and the first LED 27 is located at the rear of the projection lens 57, the individual optical components can be compactly arranged and the size of the lighting device can be reduced. Further, because the first LED 27 is hidden behind the projection lens 57, almost no internal portion of the first LED 27 can be seen from directly in the front, and an improved design can be obtained.

Additionally, in one or more embodiments, because the first reflective portion 41a, the second reflective portion 41b, and the third reflective portion 43 are integrally formed, the number of components and the manufacturing costs can be reduced, and further downsizing of the lamp is possible.

Therefore, according to the vehicle lighting device 100, the second reflective portion 41b is provided to reflect light along a level lower than the light reflected by the first reflective portion 41a. Therefore, light reflected by the second reflective portion 41b can be directed into a darker portion that is interposed between the light reflected by the first reflective portion 41a and the light component that is directly emitted to the front and downward by the first LED 27. Thus, light reflected by the second reflective portion 41b can be directed into the darker portion that is interposed between the light reflected by the first reflective portion 41a and the light component that is directly emitted by the first LED 27 to the front and downward, so that the irradiation range appears to be contiguous, and vision to the front is improved. Especially for the headlamps of a two-wheeled vehicle, because near a driver, at the front of the irradiation range, the visible area provided for the driver is large, a contiguous irradiation range can effectively improve the view to the front.

An explanation will now be given for a method (the process) for actually designing a first reflective portion 41a and a second reflective portion 41b having substantially the same structures as those described in the embodiments above.

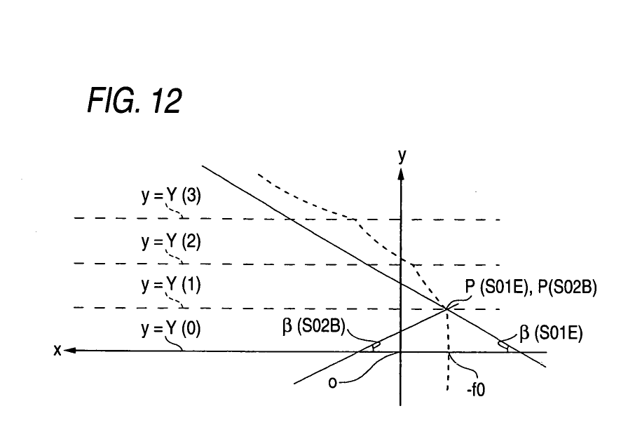

FIG. 12 is a schematic diagram for explaining the formation of the first reflective portion 41a according to the embodiment.

[Formation of the First Reflective Portion]

(1) Where a light source is the original O, a light distribution axis is the X axis, the horizontal axis is the Y axis and the vertical axis upward is the Z axis. Further, where an area Y≧0 and Z≦0 is a reflector plane, and the solid plane of y=0 of symmetry is employed as the entire shape.

(2) In the horizontal cross section Z=0, a reflector reference point is defined at the position x=−f0, the coordinates of which are (−f0, 0, 0). In one or more embodiments, f0=10 mm.

(3) On plane Z=0, a reference line is defined as a parabola, X=−f0+Y²/(4·f0) . . . (a curve Q), that employs the light source as a focal point. The curve Q is divided into N segments in the Y axial direction, and the Y coordinate values are determined. In this embodiment, N=4, Y(0)=0, Y(1)=10, Y(2)=20, Y(3)=30 and Y(4)=40 (it should be noted that the curve Q is divided by 33 mm because of a size limitation).

(4) Where the curves of the individual segments are S0n (n=1 to N), and the starting points for the individual segments are P(S0nB) and the terminal points are P(S0nE). Then, the Y coordinate of P(S0nB) is Y(n−1) and the Y coordinate of P(S0nE) is Y(n) (n≦N). Further, β is defined as the angle formed between the X axis and the reflective direction for the starting point and the terminal point of each segment.

(5-1) The reflective direction β(S01B) of the starting point of the first segment is designated as 0 °, and the reflective direction β(S01E) of the terminal point is designated as about 35°.

(5-2) When a curve (a spline curve S01) that forms an angle β(S01E) is drawn along the curve Q0, beginning at the starting point P(S01B)=(−f0, 0, 0), the coordinates of the terminal point P(S01E) are determined.

(6) A curve (a spline curve S0n) is drawn so that, as reflective directions, at the end points of the second to fourth segments, an angle β(S0nB) is about −40° and an angle β(S0nE) is about +20°. As a result, the coordinates of the next terminal point P(S0nE) can be determined. It should be noted that, basically, angle β is so designated that it is inside both the tangential line of the curve Q0 and the extension 61.

(7) Through (4) to (8), N spline reflective curves S0n in the horizontal cross section are obtained (see FIG. 12).

In the following explanation, the processing is not shown in the drawings.

(8) Sequentially, based on 2N points P(S0nB) and P(S0nE) that are end points of the individual segments S0n, 2N curves RnB and RnE are drawn downward along the vertical cross section that includes the angle β. Then, the positions lower by Z1 (Z=intersection with plane −Z1) are respectively defined as the end point P(S1nB) of the starting point, and as the end point P(S1nE) of the terminal point. A value greater than the actual reflector value is employed as Z1, and about 40 mm is currently designated. At this time, curves RnB and RnE are determined, so that for light that is emitted by the light source and reflected at P(S1nB) and P(S1nE), the reflective angle for all the Z axial components is 0 and the reflective angle for all the Y axial components is β, compared with at P(S0nB) and P(S0nE). That is, reflected light is defined as consisting of only the light component in the horizontal direction.

(9) Spline curves S1n (a total of N) are drawn by respectively employing P(S1nB) and P(S1nE) as starting points and terminal points (S1N is longer than S0N). Thus, N three-dimensional curves SSn are provided. It should be noted that the four sides of each curved face are S0n-RnE-S1n-RnB, and the vertical cross section that includes the light source is basically a parabola.

(10) Because a step occurs between the adjacent curves SSn, the front portions are extended until the two faces intersect, and these portions are defined as contiguous faces.

(11) The contiguous faces are cut into a desired size, and a reflector face is completed.

[Formation of the Second Reflective Portion]

(12) Of the three-dimensional curve SS1 (a first segment face), the portion having a width Z2 from the top end is defined as the second reflective portion (in one or more embodiments, Z2=about 8 mm).

(13) For the second reflective portion, the reflective direction in the XY plane is 0° at the starting point and 35° at the terminal point. Thus, the curve at the lower boundary of the second reflective portion is a spline curve S31 that is a crossline between the first reflective portion and Z=−Z2 (a horizontal cross section). The reflective directions at the starting point P(S31B) and the terminal point P(S31E) of the spline curve S31 are β(31B)=0° and β(31E)=35°, respectively.

(14) Following this, in the XZ plane (a vertical cross section of Y=0), based on the starting point P(S31B), an almost elliptical curve is drawn upward to Z≅0 while the first focal point is regarded as the light source, and the second focal point is regarded as the position from the light source “a distance of about 15 mm forward and downward near Z2” (X≅15, Y=0, Z≅−8). The obtained curve is defined as a curve D1B in the plane of Y=0 for the second reflective portion.

(15) Then, the curve D1B is moved horizontally along the curve S31 to point P(S31E), and the obtained curve is defined as a curve D1E. At this time, the horizontal reflective angle β of light that is emitted by the light source and reflected near the face along the curve D1E is about 35°. Thus, the resultant face serves as a reflective face whereon light is difflused and output to the front and downward by the lamp, by employing, as the second focal point, a point near the coordinates (X≅15, Z≅−8), in the vertical cross section, including the reflective direction.

In this manner, the three-dimensional curved face formed by the curves D1B, S31, and D1E is employed as the second reflective portion.

According to one or more embodiments of the invention, the reflective face formed by the first reflective portion and the second reflective portion is prepared by employing the above described method.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

[Description of the Reference Numerals and Signs]

19: light source holder

23: second LED

27: first LED

41: first reflective portion

41a: reflective face

41C1: central reflective segment

41C2: connection reflective segment

43: third reflective portion

57: projection lens

41b: second reflective portion

81: light control member (linear light blocking unit)

100: vehicle lighting device

200: lamp unit (PES lamp unit)

300: lamp unit (reflection type lamp unit)

What is claimed is:

1. A vehicle lighting device comprising:
a reflection type lamp unit comprising:
a first LED that emits light downward; and
a reflective face that reflects part of the light emitted by the first LED outward to the front of the vehicle lighting device,
wherein part of the light emitted by the first LED is output, as directly emitted light, directly to the front of the vehicle lighting device, and
wherein the reflective face comprises:
a first reflective portion that reflects light as vertically almost parallel light and as horizontally diffused light, and
a second reflective portion that reflects light below the light reflected by the first reflective portion and above the directly emitted light.

2. The vehicle lighting device according to claim 1, wherein the first reflective portion and the second reflective portion are integrally formed, and wherein the second reflective portion is located near an upper end of the reflective face.

3. The vehicle lighting device according to claim 1, wherein the first reflective portion is formed of a plurality of reflective segments such that adjacent segments are contiguously formed and extended substantially vertically; wherein the plurality of reflective segments comprise a central reflective segment located below the first LED; and wherein the second reflective portion is formed and connected to the central reflective segment.

4. The vehicle lighting device according to claim 1, further comprising:
a PES lamp unit, which forms a cut line pattern, comprising:
a second LED that emits light upward;
a third reflective portion that reflects light emitted by the second LED;
a linear light blocking portion that reflects part of the light reflected by the third reflective portion; and
a projection lens,
wherein the second LED and the first LED are arranged on an upper face and a lower face of a horizontally arranged light source holder, and
wherein the first LED is located to the rear of the projection lens.

5. The vehicle lighting device according to claim 4, wherein the first reflective portion, the second reflective portion, and the third reflective portion are integrally formed.

6. The vehicle lighting device according to claim 2, wherein the first reflective portion is formed of a plurality of reflective segments such that adjacent segments are contiguously formed and extended substantially vertically; wherein the plurality of reflective segments comprise a central reflective segment located below the first LED; and wherein the second reflective portion is formed and connected to the central reflective segment.

7. The vehicle lighting device according to claim 2, further comprising:
a PES lamp unit, which forms a cut line pattern, comprising:
a second LED that emits light upward;
a third reflective portion that reflects light emitted by the second LED;
a linear light blocking portion that reflects part of the light reflected by the third reflective portion; and
a projection lens,
wherein the second LED and the first LED are arranged on an upper face and a lower face of a horizontally arranged light source holder, and
wherein the first LED is located to the rear of the projection lens.

8. The vehicle lighting device according to claim 3, further comprising:
a PES lamp unit, which forms a cut line pattern, comprising:
a second LED that emits light upward;
a third reflective portion that reflects light emitted by the second LED;
a linear light blocking portion that reflects part of the light reflected by the third reflective portion; and
a projection lens,
wherein the second LED and the first LED are arranged on an upper face and a lower face of a horizontally arranged light source holder, and
wherein the first LED is located to the rear of the projection lens.

9. A vehicle lighting device according to claim 7, wherein the first reflective portion, the second reflective portion, and the third reflective portion are integrally formed.

10. A vehicle lighting device according to claim 8, wherein the first reflective portion, the second reflective portion, and the third reflective portion are integrally formed.
